(19) United States
(12) Patent Application Publication
(10) Pub. No.: US 2019/0070057 A1
(43) Pub. Date: Mar. 7, 2019

(54) Lifepace Vibraband System

(71) Applicants: Rachel J. Conner, Poland, OH (US); Brett P. Conner, Poland, OH (US)

(72) Inventors: Rachel J. Conner, Poland, OH (US); Brett P. Conner, Poland, OH (US)

(21) Appl. No.: 15/693,934

(22) Filed: Sep. 1, 2017

(51) Int. Cl. A61H 1/00

(52) U.S. Cl. CPC A61H 1/00; A61H 2201/165; A61H 2201/5097; A61H 2201/5007; A61H 2201/5043; A61H 2201/5002

(57) ABSTRACT

A vibration system is provided that, in some embodiments, may provide for wearable bracelets, bands, or other wearable structures that may contain vibration or tapping elements, wherein the vibration or tapping instruments may be configured to provide bilateral stimulation.

### CROSS-REFERENCE TO RELATED APPLICATION

Not applicable.

### TECHNICAL FIELD

The present invention relates generally to the field of vibrational therapy instruments and more specifically relates to a vibrating wearable band system.

### BACKGROUND

Trauma is a very little understood phenomenon among the general public. Bilateral stimulation has the power to reduce suffering from natural disasters, acts of violence, and other traumatic events.

The biological effects of trauma are obvious in some ways: repetitive thoughts of the traumatic event, inability to sleep, changes in eating or personal grooming, and so on. These observable changes are rooted in the biology of the brain. In the wake of trauma, the brain becomes frozen. These effects linger in the area of decision making even after observable changes have stopped. People who are frozen with trauma cannot decide on a course of action that is appropriate for their current circumstances, but rather revert to avoidance behaviors based on events that happened in the past.

Additionally, people with past trauma history often go to great lengths to avoid triggers because of the frozen mind and body they experience when they are triggered. Bilateral stimulation directly treats the frozen mind and body, providing relaxation so the brain and body can resume normal function. This allows triggers to be quickly resolved, even if there has not been much time since the incident. Bilateral stimulation allows a traumatic memory to become a non-traumatic memory. After bilateral stimulation, people find that their creative problem-solving skills are unleashed with the clear thinking that is possible without the impediment of trauma's aftermath.

Research on trauma reveals a repeated connection between the trauma that is caused by one-time events like violence and natural disasters, and the trauma that is caused by repeated events of emotional, physical, or sexual violence that is also known as abuse. Not only are people with one kind of trauma injury more likely to develop post-traumatic stress disorder (PTSD) later in life when a new trauma occurs, but the symptoms that both groups experience have so many common denominators that books that address trauma toggle between the two forms of trauma repeatedly.

Some persons who need assistance are adults who are experiencing stress—whether or not the stress is known to be trauma-related, it probably has a trauma component and these adults can benefit.

Other people who need assistance are parents whose children are experiencing stress. The parents may benefit from a wearable device. These children's devices would be sold with a caregiver device that would vibrate whenever the child's device was triggered. Not only would this let the caregiver monitor the child's well-being and treatment, but it would also allow the caregiver to receive an extra dose of peace from receiving bilateral stimulation when the child is experiencing problems. In such a scenario, school-aged children would most likely wear a child-sized version of the adult product, since they would not be close to a caregiver for as many hours. (Or the school-aged product may operate autonomously when the caregiver device was not present.) These devices would obviously benefit a child with a known trauma, such as adoption or family member illness or death. However, these devices may also be used for any health condition that impairs normal development of children (autism, bipolar disorder, physical deformities, or many others), because the aberration of normal human development is a trauma for the parent (depending on the aberration it can also be a trauma to the child), and causes the parent to experience stress that may influence the parent to cause more traumatic experiences because of their anxiety about their children. Additionally, children with abnormal development experience traumas in their relationships with other caregivers and peers. All of these traumas may benefit from the increased ability to engage in problem-solving.

Third, people experiencing chronic pain are in need of assistance. Recent breakthroughs in the treatment of chronic pain have revealed that it is rooted in past trauma. Even chronic pain that is from a visible cause (the kind that is seen on an x-ray, for example) is rooted in the body's inability to bring healing to the area. Some common forms of chronic pain that may respond well to the physical comfort of bilateral stimulation include back pain and headaches. This area is being explored in various books available to the public.

In light of this connection between trauma and abuse, other treatment options include the treatment of multiple family members simultaneously with bracelets that may calm nerves and de-escalate family tension to allow family members to discover options they did not know previously existed for family conflict resolution. The existing applications for family-based interventions may include parenting suggestions on parent devices, or even biometric warning signals for family members who may avoid confrontation when certain biometric conditions were present. Such devices may never replace counseling, of course, but they may add healthcare access and options. Therefore, a need for systems to meet these and other needs exists. Furthermore, a need for a wireless such system exists as well. Such a system would be a major difference from current technology. Wireless means that stimulation can be provided anywhere the user is and at any time. Wireless devices also allow for discreet application of the treatment.

Various attempts to solve this problem have been made. One such attempt can be seen with respect to U.S. Patent Application Publication No. 2007/0100262, incorporated by reference in its entirety herein, which generally discloses a vibrating bracelet that is intended to soothe its wearer. While this disclosure does enable a user to receive calming vibrations, it fails to provide for a sophisticated bilateral vibratory program.

Another attempt can be seen with respect to U.S. Pat. No. 8,265,692, incorporated by reference in its entirety herein, which generally discloses a wrist-worn bracelet having multiple interface functionalities with a mobile phone. While this disclosure does provide for multiple vibration-related functionalities, such as notifications via vibrations, it fails to provide for a therapeutic vibratory experience.

Yet another attempt can be seen with respect to U.S. Pat. No. 6,912,287, incorporated by reference in its entirety herein, which generally discloses a wrist-worn accessory designed to be used in conjunction with a mobile phone. Essentially a wearable mobile phone, this disclosure fails to offer a therapeutic vibratory experience, instead offering its users the ability to initiate a vibratory sequence, such as a tapping motion, to initiate a mobile phone function.

Various attempts have been made to solve the problems which may be found in the related art but have thus far been unsuccessful. A need exists for a new vibrating wearable band system that provides bilateral stimulation band to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a vibrating wearable band that overcomes the deficiencies of the prior art. It is contemplated that the present invention may provide a bilateral therapeutic vibratory stimulation and therapy to one or more users.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel vibrating wearable band. The general purpose of the present invention, which will be described subsequently in greater detail, is to provide a therapeutic bilateral stimulation through vibrations applied at key bodily locations. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a system of wearable bracelets, which in some embodiments may include bands worn around the legs or ankles, or bands or clothing worn around the waist, the chest (as for example a vest), or the head (as for example a hat), or in some embodiments integrated into a helmet, or in some embodiments as paired with multiple devices on multiple locations on the human body. In the case of multiple paired devices, the present invention may provide for color-coded, lettered, or numbered indicia for visual reference, as well as one or more mechanical nodes that may be placed in clothing, socks or footwear, for people with sensory issues. Finally, in some alternative embodiments, the present invention may provide for a pair of bands (or multiple pair of bands) managed by a smart device such as a smart phone or smart watch. In such an embodiment, and in other such embodiments, the present invention may provide for a non-transitory, tangible computer-readable medium having stored thereon computer-executable instructions, which, when executed by a computer processor, enable performance of a method, wherein the method is configured to operate or cause a machine to operate one or more bands to vibrate or otherwise behave according to the present invention.

The present invention's devices, elements, or other components of the system may contain a means of vibration or tapping. The vibration means may provide what is called “bilateral stimulation.” As here used, bilateral stimulation involves a stimulus (in this case vibration) on one side of the body following by the mirror stimulus on the other side of the body. This has been shown to provide relief for trauma related anxiety including PTSD.

One or more elements or aspects of bilateral stimulation that may be provided by the present invention may include that the bilateral stimulation elements may be placed on opposite sides of the body to stimulate opposite sides of the brain (without, in some embodiments, the positioning of limbs across the midline of the body, so as to ensure proper brain stimulation). The bilateral stimulation may be sequential (that is, on one side of the body first, then the other). With repetition this stimulation may become an alternating pattern (i.e. one side, the other side, again the first side, then the second side). In order to prevent the brain from tuning out the stimulation, the pattern of the vibration or tapping may vary. For example, the vibration or tapping may be varied in intensity, frequency, duration of “pulse,” duration of stimulation, and location of vibration or tapping. Stimulation may be provided on demand (at the request of the wearer or a caregiver/parent) or on a programmed schedule. Stimulation may be provided on demand (at the request of the wearer or a caregiver/parent) or on a programmed schedule. Stimulation may also be provided following a biometric cue such as a sudden increase in heart rate indicating panic (this would treat trauma-induced panic), or an onset of sleepiness shown by a drop in activity that is coordinated with a time of day that has been a habitual bedtime for the wearer of the device (this would reinforce proper circadian rhythm, reducing trauma-induced fear of sleep and also having implications for other conditions in which circadian rhythm is an important factor).

Furthermore, in some embodiments, the present invention may provide for wearable bracelets/bands or other wearable structures that may contain vibration or tapping stimulation. The example of bracelets will be used for explaining the concept, although the present invention is not limited to bracelets, as has been provided elsewhere in the present disclosure.

In some embodiments, a bracelet device according to the present invention may be configured to be worn on a user's wrist, and may have a user interface for a user to request stimulation. This user input may include a user scheduling stimulation treatment to happen at specific times during the day or certain days of the week (much like programming an alarm clock). The bracelet device may communicate wirelessly the request to the bracelet on the opposite wrist the following: a.) that stimulation is requested, b.) the pattern of stimulation (intensity, duration of “pulse”, ramp, duration of stimulation, and, assuming there is more than one stimulator on the bracelet element, the location of vibration or tapping), as well as c.) any necessary timing information to make sure the stimulation is timed in a sequential fashion.

With respect to the pattern of stimulation, “intensity” refers to the maximum amount of force imparted during a vibration or tap, “duration of pulse” is the length at which at which a given tap or vibration is held, “ramp” is the rate at which the force is applied (a portion of the duration of pulse is the “duration of maximum intensity” which is the length of time the maximum intensity of force is applied), “duration between pulses” is the length of time between pulses, and “duration of stimulation” is the total length of time the stimulation is applied. For embodiments of the present invention (“devices”) that have more than one stimulation source (i.e. vibration engine or tapping motor) on the device, the “location of pulse” can also be selected. These characteristics can also be expressed as a vibrational waveform of the summation of vibrating waves that are modified through modulation. For bilateral simulation to occur the same pattern of simulation must be applied to the opposite sides of the body, one after the other.

For ease of use, predetermined patterns of stimulation can be included in each device or the master device. For sophisticated users such as therapists, parameters can be adjusted. A device may have preprogrammed stimulation patterns, adjustable patterns, or both.

One bracelet device may be the master and the other may be the follower or “slave.” Alternatively, both bracelet devices may be the same device. Each bracelet device may have a single stimulator or it may have multiple stimulators (multiple stimulators would provide additional variety to keep the brain from tuning out the stimulation).

The user interface may be simple such as buttons or it may include additional functionality through a graphical user interface that can include items such as a watch or a fitness application, or a reminder device to remind the user about healthy habits he or she is wanting to instill in himself or herself. In a master/follower pairing, a smartwatch may be one of the bracelet devices and the other may be a follower bracelet device. Alternatively, both bracelet devices may be followers and the master be a smart phone or a caregiver's device. If desired, the smart watch or smart phone may record usage patterns or biometric information, and may transmit that information for analysis (to improve device function for the individual user or the global population of device users). This transmission may be to a local data storage device (smartphone or computer), or the database of healthcare professional who may use the information to uncover triggers or patterns that may warrant therapy, or (anonymously) to the manufacturer for product improvements. Alternatively, the master device may have means to store and later download data to a computer or smart device.

The smartwatch user interface may allow users to pair the device with a smartphone or computer that may send and receive information by wireless transmission (Bluetooth). This pairing may allow the device to be triggered or controlled through the app interface. This pairing may allow the device to have internet access for updates and information transmission without the use of cell technology on the device itself.

Additionally, the app can deliver timely advice and patient education that can steer the user to alternatives for stress reduction that fit their current location and circumstances. New ideas (techniques that are currently provided only by therapists, each of which specialize in one or two ideas rather than the full spectrum of helpful ideas) for coping with trauma-related stress feelings, as well as stress caused by everyday life, provide symptom relief that outperforms what a single modality can deliver. Through the app, users may even have access to online mental healthcare providers that may give additional care and referrals similar to a hotline. This idea has another possible application in the administration of healthcare of all kinds, as artificial intelligence is able to give advice and education when and where it is needed, if it is given a diagnosis previously determined by a doctor or other healthcare professional. Although this concept is sound for a variety of medical conditions, it is uniquely significant for mental diagnoses are the best of this kind of continual presence of a healthcare caregiver because they involve an impairment of the patient's ability to retain and apply information. This watch and app can function as a coach to mental wellness, enabling results that have been previously unheard of.

The unique features of the present invention may provide the following benefits for one or more consumers: it may reduce stress or anxiety caused by the fear of a traumatic event or relationship. It may reduce stress or anxiety due to the many minor traumas that cause anxiety in everyday life for people with or without a medical diagnosis. It may empower the user to take control of his or her own mind and body to achieve the results he or she wants to see. It may provide on demand relief anytime and at any place where the wearer happens to be. With wireless stimulation, it may provide for a convenient and wireless solution with no cords needed. It may provide treatment timing between the system's elements, bands, or devices (timing of the stimulation and the stimulation pattern such as intensity, duration, or cadence is critical to successful application of bilateral stimulation treatment). Such may be enabled by the present invention by wirelessly synchronized devices that deliver stimulation at the correct time and location. For example, in some embodiments, the “master” device may receive input from user or app, contains the master clock and transmits instructions to the “slave” devices. It may provide app-based coaching of the wearer to try various stress-reducing tips. It may enable doctors and/or counselors to receive information about the function and stressors of their patients, and to unlock new treatment possibilities. It may provide that stimulation can be activated by sensing biometrics signatures such as body heat or heart rate when the wearer is stressed.

### BRIEF DESCRIPTION OF THE DRAWINGS

These and other features, aspects and advantages of the present invention will become better understood with regard to the following description, appended claims, and accompanying figures where:

FIG. 1 shows a front perspective view of an embodiment of a vibration system in accordance with one embodiment of the invention.

FIG. 2 shows a front perspective view of an embodiment of a vibration system in accordance with one embodiment of the invention.

FIG. 3 shows a side perspective view of an embodiment of a vibration system in accordance with one embodiment of the invention.

FIG. 4 shows a rear perspective view of an embodiment of a vibration system in accordance with one embodiment of the invention.

FIGS. 5A and 5B illustrate several placements of several embodiments of a vibration system on a user.

FIG. 6 is a visual representation of tapping or vibration pulsing from the devices.

FIG. 7 is a visual representation of bilateral stimulation between two devices that are paired and on each side of the body.

### DETAILED DESCRIPTION

The present invention overcomes the limitations of the prior art by providing a new and more effective vibration system utilizing wearable bands.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

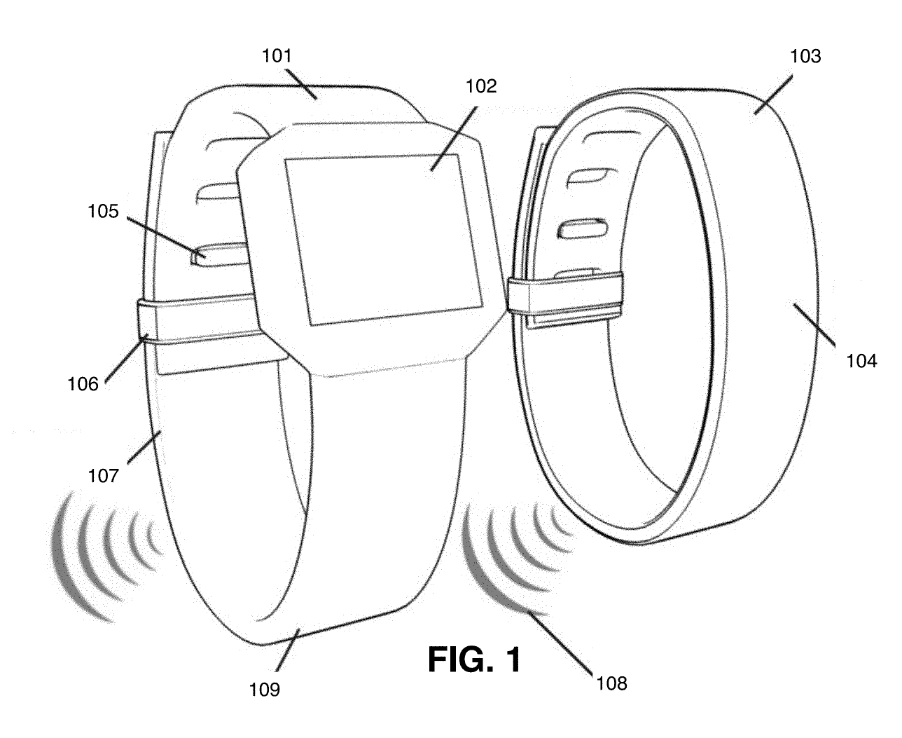

Turning attention to FIG. 1, a front perspective view of an embodiment of a vibration system in accordance with one embodiment of the invention is shown. In the embodiment depicted, a viewer may perceive master unit 101, LED display 102, slave unit 103, vibration motor(s) 104 (inside watch strap 107), strap lock 105, strap keeper 106, watch strap 107, wireless connection 108 (that may enable master unit 101 and slave unit 103 to work together), and alternating vibrations 109 (that may help with PTSD or anxiety).

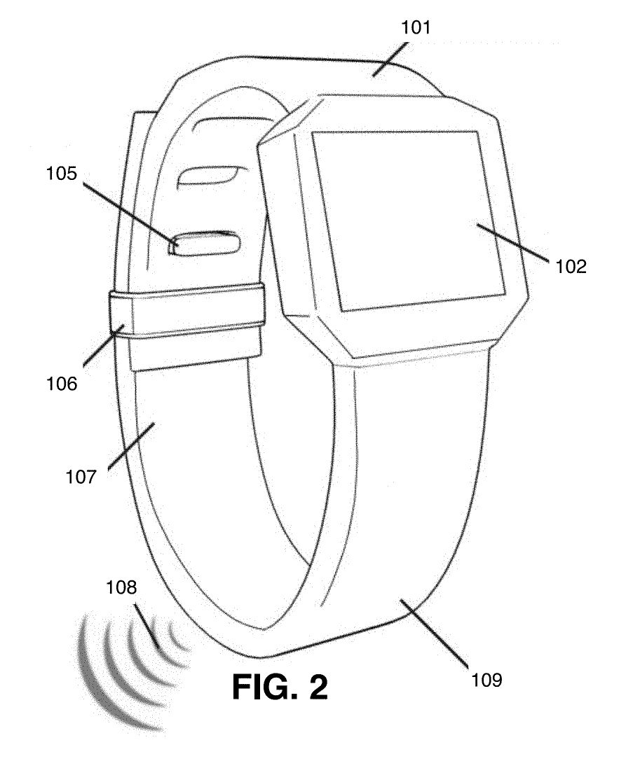

With respect to FIG. 2, a front perspective view of an embodiment of a vibration system in accordance with one embodiment of the invention is shown. In the embodiment depicted, a viewer may perceive master unit 101, LED display 102, strap lock 105, strap keeper 106, watch strap 107, wireless connection 108, and alternating vibrations 109.

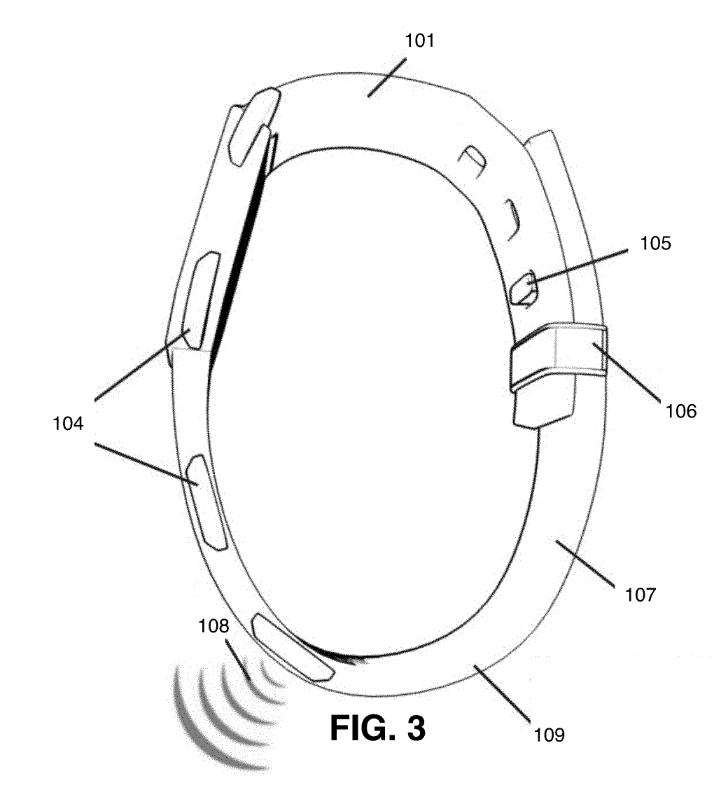

With respect to FIG. 3, a side perspective view of an embodiment of a vibration system in accordance with one embodiment of the invention is shown. In the embodiment depicted, a viewer may perceive master unit 101, vibration motor(s) 104, strap lock 105, strap keeper 106, watch strap 107, wireless connection 108, and alternating vibrations 109.

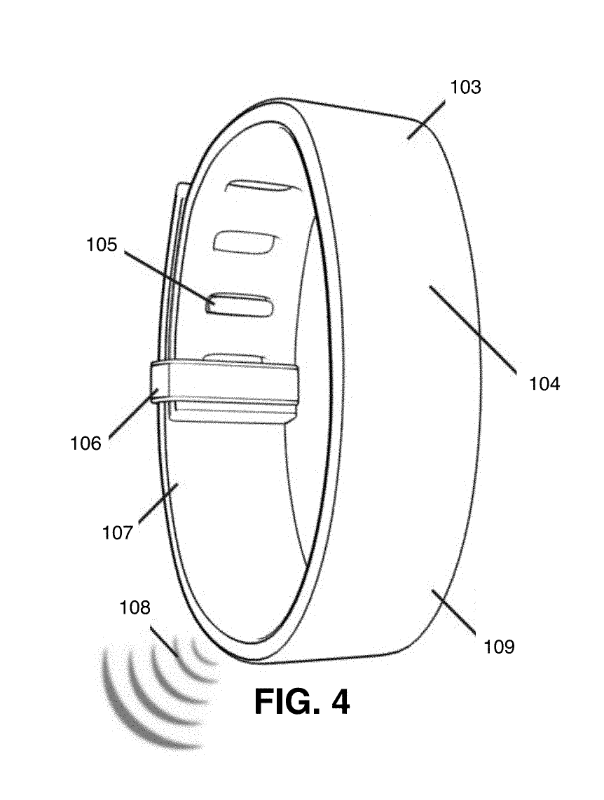

With respect to FIG. 4, a rear perspective view of an embodiment of a vibration system in accordance with one embodiment of the invention is shown. In the embodiment depicted, a viewer may perceive slave unit 103, vibration motor(s) 104, strap lock 105, strap keeper 106, watch strap 107, wireless connection 108, and alternating vibrations 109.

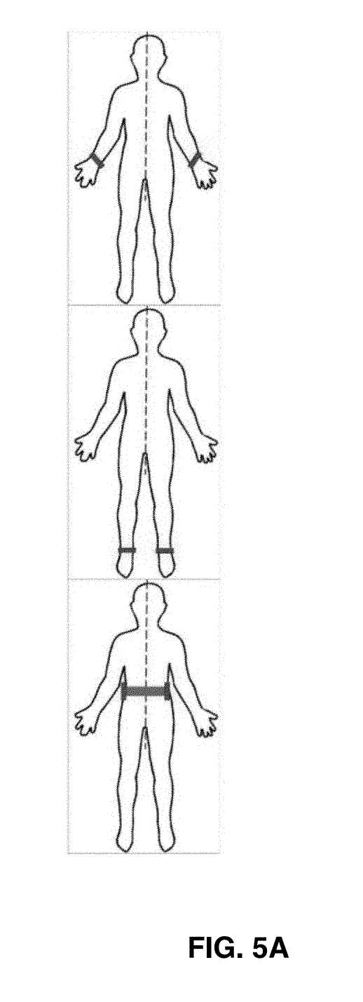

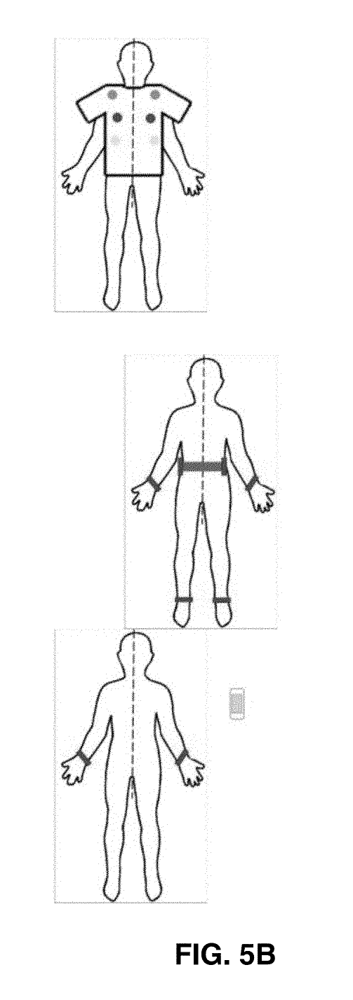

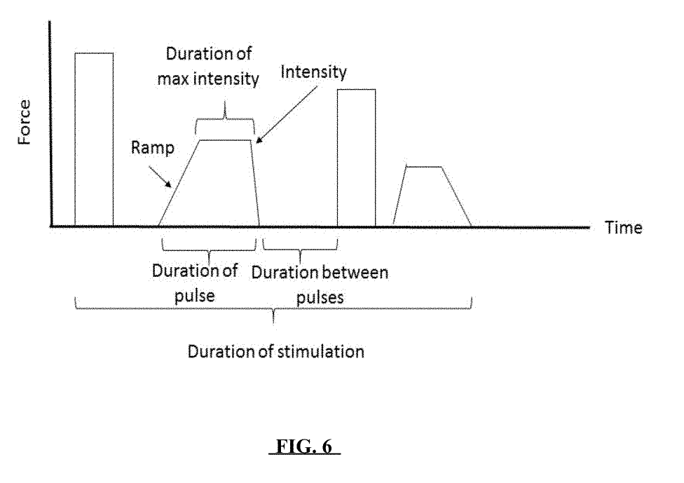

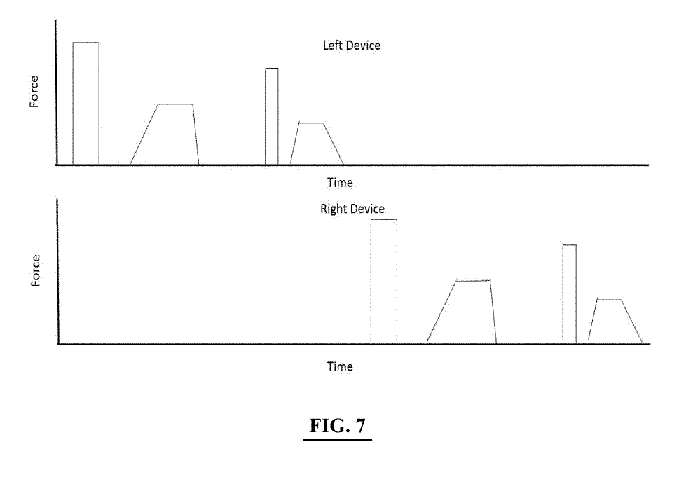

FIGS. 5A and 5B illustrate several placements of several embodiments of a vibration system on a user. In these embodiments, a user may perceive the present invention shown in a bracelet form, wherein the user wears one on each arm; the present invention shown in a bracelet or band form, wherein one device is worn around each ankle; the present invention shown in the form of a belt or band around the torso or waist, wherein a device is contained on the left and right side of the wearer; the present invention shown as multiple devices worn by the user providing many locations on the body to provide relief; the present invention shown as stimulation nodes placed in user's clothing, wherein paired the stimulation nodes are color-coded to ensure they are placed as pairs; and the present invention shown as bands or bracelets that interact with a smart phone.

### CONCLUSIONS, RAMIFICATIONS, AND SCOPE

Although the present invention has been described with a degree of particularity, it is understood that the present disclosure has been made by way of example and that other versions are possible. As various changes may be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the vibration system generally described herein has been disclosed in connection with a number of embodiments shown and described in detail, various modifications should be readily apparent to those of skill in the art.

What is claimed is:

1. A vibration system, comprising:
at least one wearable elements, at least one processor configured to receive data via a wireless connection, and at least two vibration elements, wherein the processor is configured to send one or more vibration instructions to at least one vibration element.

2. The system of claim 1 where the vibration elements are paired with at least one wearable element.

3. The system of claim 2 where both the wearable and vibration elements are slave devices controlled by a mobile device.

4. The system of claim 2, wherein at least one wearable element comprises a master unit having a display, a band, at least one vibration motor fixedly connected to the band element, by and through a connection member.

5. The system of claim 4, further comprising a slave unit having a display, a band, at least one vibration motor fixedly connected to the band element, by and through a connection member, wherein the at least one processor of the master unit is configured to cause the at least one processor of the slave unit to mirror the vibration instructions sent by the at least one processor of the master unit.

6. The system of claim 5, further comprising instructions from a mobile device, wherein the instructions are configured to cause the at least one processor of the master unit to send at least one vibration signal to the at least one vibration element according to the instructions of the mobile device.

7. The system of claim 6, wherein the instructions from the mobile device cause the at least one processor of the master unit to send at least one vibration signal providing for bilateral stimulation to the at least one vibration element according to the instructions of the mobile device.

8. The system of claim 7, wherein the mobile device records and or transmits data and information to the wearer or a third party.

9. A vibration system, comprising:
at least one wearable elements, at least one processor configured to receive data via a wireless connection, and at least two vibration elements, wherein the processor is configured to send one or more vibration instructions to at least one vibration element.

10. The system of claim 9, wherein the wearable element is a belt.

11. The system of claim 9, wherein the wearable element is a vest.

12. The system of claim 9, wherein the wearable element is a band.

13. The system of claim 9, wherein the wearable element has inserts where vibrational elements are added and removed.
